(19) United States
(12) Patent Application Publication
(10) Pub. No.: US 2018/0283151 A1
(43) Pub. Date: Oct. 4, 2018

(54) FRACTURING MANIFOLD ALIGNMENT SYSTEMS

(71) Applicant: FMC Technologies, Inc., Houston, TX (US)

(72) Inventors: James Cook, Houston, TX (US); Justin Taylor, Houston, TX (US)

(73) Assignee: FMC Technologies, Inc., Houston, TX (US)

(21) Appl. No.: 15/943,364

(22) Filed: Apr. 2, 2018

Related U.S. Application Data
(60) Provisional application No. 62/480,826, filed on Apr. 3, 2017.

(51) Int. Cl. E21B 43/26; E21B 17/02; E21B 34/02; F16L 27/08

(52) U.S. Cl. CPC E21B 43/26; E21B 17/02; F16L 2201/00; F16L 27/0804; E21B 34/02

(57) ABSTRACT

A manifold alignment system includes a first modular skid with a first frame, the first frame having a first end with at least one first sloped surface, a second modular skid with a second frame, the second frame having a second end with at least one second sloped surface, wherein the at least one first sloped surface mates with the at least one second sloped surface, and a removably mounted hydraulic mechanism attached to the first end of the first skid and the second end of the second skid.

### CROSS-REFERENCE TO RELATED APPLICATIONS

This application claims benefit, under 35 U.S.C. § 119, of U.S. Provisional Application Ser. No. 62/480,826 filed on Apr. 3, 2017 and entitled “Fracturing Manifold Alignment Systems.” The disclosure of this U.S. Provisional application is incorporated herein by reference in its entirety.

### BACKGROUND

Hydraulic fracturing is a stimulation treatment routinely performed on oil and gas wells in low-permeability reservoirs. Specially engineered fluids are pumped at high pressure and rate into the reservoir interval to be treated, causing a vertical fracture to open. The wings of the fracture extend away from the wellbore in opposing directions according to the natural stresses within the formation. Proppant, such as grains of sand of a particular size, is mixed with the treatment fluid to keep the fracture open when the treatment is complete. Hydraulic fracturing creates high-conductivity communication with a large area of formation and bypasses any damage that may exist in the near-wellbore area. Furthermore, hydraulic fracturing is used to increase the rate at which fluids, such as petroleum, water, or natural gas can be recovered from subterranean natural reservoirs. Reservoirs are typically porous sandstones, limestones or dolomite rocks, but also include “unconventional reservoirs” such as shale rock or coal beds. Hydraulic fracturing enables the extraction of natural gas and oil from rock formations deep below the earth's surface (e.g., generally 2,000-6,000 m (5,000-20,000 ft)), which is greatly below typical groundwater reservoir levels. At such depth, there may be insufficient permeability or reservoir pressure to allow natural gas and oil to flow from the rock into the wellbore at high economic return. Thus, creating conductive fractures in the rock is instrumental in extraction from naturally impermeable shale reservoirs.

A wide variety of hydraulic fracturing equipment is used in oil and natural gas fields such as a slurry blender, one or more high-pressure, high-volume fracturing pumps and a monitoring unit. Additionally, associated equipment includes fracturing tanks, one or more units for storage and handling of proppant, high-pressure treating iron, a chemical additive unit (used to accurately monitor chemical addition), low-pressure flexible hoses, and many gauges and meters for flow rate, fluid density, and treating pressure. Fracturing equipment operates over a range of pressures and injection rates, and can reach up to 100 megapascals (15,000 psi) and 265 litres per second (9.4 cu ft/s) (100 barrels per minute).

Conventional methods to connect the equipment currently use big bore manifolds (e.g., having 7 inch bores) deployed in pipe segments that must be flanged together on site. Given the size and weight of the pipe segments, properly aligning the spools rotationally (to line up the bolt holes) and axially (so that are near enough for the bolted connection and are not tilted with respect to one another) can prove to be very challenging on site. The aforementioned difficulties increase the time it takes to establish the proper connections required. Furthermore, recent trends have shifted frac manifolds toward bigger bore monoline manifolds. However, bigger bore monoline manifolds, are likewise deployed in pipe segments that are flanged together on site. Thus, the bigger bore monoline manifolds also require a significant amount of work on the part of field workers, who must manipulate the segments to rotationally align the bolt holes and establish a coaxial alignment of the pipe segments to allow the bolts to be inserted and torqued.

FIG. 1 illustrates an example of an existing fracturing pad system 100 (often referred to as a “frac pad” system in the industry). The fracturing pad system 100 includes at least one pump truck 102 connected to a missile manifold 104 via fluid connections 106. Additionally, a blending system 108 may be connected to the pump trucks 102 through one or more hoses 110 to supply proppant and other particulates to the pump trucks 102 to pump into the well (not shown) as part of the fracturing process. The missile trailer 104 may be connected to an isolation valve structure 112 that, for instance, can include a safety valve that may open to relieve pressure in the system under certain conditions. The valve structure 112 may be connected to at least one manifold 114 through a pipe spool 116 that is a plurality of pipes flanged together, for instance. As can be seen from FIG. 1, the fracturing pad system 100 includes many, non-uniform connections that must be made up and pressure tested, including the conduits to/from the pump trucks 102, missile trailer 104, and blending system 108. Furthermore, the connections between the missile manifold 104 and valve structure 112, and the pipe spool 116 between the valve structure 112 and the manifolds 114 are also non-uniform connections that must be made up and pressure tested. These connections take valuable time and resources on site. Additionally, the fracturing pad system 100 is generally not flexible regarding the number of pumps that can be used.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments of the present disclosure relate to a manifold alignment system that includes a first modular skid with a first frame, the first frame having a first end with at least one first sloped surface, a second modular skid with a second frame, the second frame having a second end with at least one second sloped surface, wherein the at least one first sloped surface mates with the at least one second sloped surface, and a removably mounted hydraulic mechanism attached to the first end of the first skid and the second end of the second skid.

In another aspect, embodiments of the present disclosure relate to a method of aligning a plurality of skids that includes pulling a first modular skid towards a second modular skid with a removably mounted hydraulic mechanism or a crane, wherein the first modular skid has a first frame and the second skid has a second frame, axially aligning a first manifold connection on the first modular skid with a second manifold connection on the second modular skid, and closing a rotationally independent connector around axially aligned ends of the first manifold connection and the second manifold connection to fluidly connect the first manifold connection to the second manifold connection.

Other aspects and advantages will be apparent from the following description and the appended claims.

### BRIEF DESCRIPTION OF DRAWINGS

FIG. 1 is a block diagram of a conventional fracturing pad system.

FIG. 2 is a perspective view of a modular fracturing pad system in accordance with one or more embodiments of the present disclosure.

FIG. 3 is a perspective view of a modular fracturing pad system in accordance with one or more embodiments of the present disclosure

FIGS. 4A-4C are perspective views of a fracturing manifold alignment system in accordance with one or more embodiments of the present disclosure.

FIGS. 5A-5B are perspective views of a manifold connections in accordance with one or more embodiments of the present disclosure.

FIGS. 6A-6C are perspective views of trailer chassis in accordance with one or more embodiments of the present disclosure.

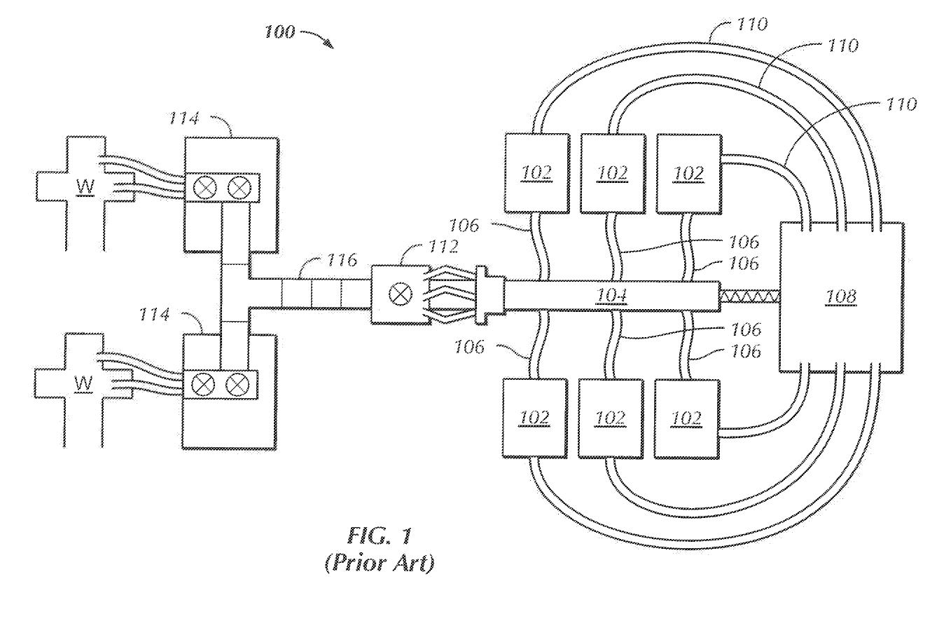

### DETAILED DESCRIPTION

In one aspect, embodiments disclosed herein relate to a modular fracturing pad system. The modular fracturing pad system may also be interchangeably referred to as a modular skid system in the present disclosure. As used herein, the term “coupled” or “coupled to” or “connected” or “connected to” may indicate establishing either a direct or indirect connection, and is not limited to either unless expressly referenced as such. Wherever possible, like or identical reference numerals are used in the figures to identify common or the same elements. The figures are not necessarily to scale and certain features and certain views of the figures may be shown exaggerated in scale for purposes of clarification.

A modular skid system, according to embodiments herein, is a system in which the elements of a hydraulic fracturing system are modularized and deployed on connectable skids that can be secured together to form an integrated fracturing structure capable of spanning from the outlet of a hydraulic fracturing pump to the wellhead. The hydraulic fracturing system elements are modularized in a way such that the primary manifolds/flow functionality is made up when the skids are connected. Further, the modularized hydraulic fracturing system elements may be held on units having standardized uniform connections, such that different types of hydraulic fracturing system element units may be connected together using the same connection type. The reduction of using non-uniform connections that must be made up and pressure tested may significantly reduce the complexity, design, time, and weight of the system.

Modular skid systems of the present disclosure may include, for example, systems for use in hydraulic fracturing (e.g., where a fracturing modular skid system may be used to direct fluid from one or more pumps to be injected into one or more wellheads in a fracturing operation), in post-drilling operations (e.g., where the modular skid system may include one or more modularized skids holding flowback equipment, such as junk catchers, desanders, choke manifolds, etc.), and/or in other wellbore operations, where modular skids may be used to direct fluid produced from and/or injected into a well. As used herein, fluids may refer to proppant, liquids, gases, and/or mixtures thereof. Other instruments and devices, including without limitation, sensors and various valves may be incorporated within a modular skid system.

Conventional wellbore operation systems (e.g., hydraulic fracturing pad systems) in the oil and gas industry typically consume a large amount of space and resources of a rig area. Conventional wellbore operation systems may use elements that are individually designed and sized with pipes, flow lines, and other conduits being used to interconnect the elements of the system. Furthermore, pipes, flow lines, and other conduits being used to interconnect the conventional wellbore operation systems are not uniform and take valuable time to make up and pressure test. Additionally, the sheer number of pipes, hoses, and other fluid connections represent safety hazards for on-site workers. This additional need of more components needed to interconnect the conventional wellbore operation systems adds to the weight, installation costs, and overall cost of the system. However, using modular skid systems according to one or more embodiments of the present disclosure may overcome such challenges, as well as, provide additional advantages over conventional fracturing systems.

In one or more embodiments, a modular skid system may include purpose built, same-sized modular skids that are connected together to form a multi-functional super structure for use in wellbore operations. As used herein, purpose built modular skids may include modular skids having known and/or new equipment that serves a certain purpose or performs a certain job. For example, a modular skid according to embodiments of the present disclosure may have a known type of isolation valve mounted thereto or may have a new type of isolation manifold mounted thereto, where at least one purpose of the purpose built modular skid is to selectively isolate flow or fluid through the modular skid. Other equipment types currently known and/or unknown in the art (e.g., as shown in some of the examples provided herein) may be utilized in modular skids according to embodiments of the present disclosure.

Modular skids according to embodiments of the present disclosure may have standardized uniform mounting footprints, whether same-type or different-type equipment is mounted to the modular skids. In other words, a modular skid system according to embodiments of the present disclosure may include modular skids having same and/or different equipment configurations held on each modular skid, where each modular skid in the modular skid system may have the same mounting footprint. As used herein, a mounting footprint may refer to the size (width and length) of a base of a modular skid. Thus, in one or more embodiments, modular skids having different equipment units may have the same mounting footprint whether or not the different equipment units have different heights and/or elements of the different equipment units have different dimensions that swing or extend outward of the modular skid mounting footprint. For example, a modular skid system according to embodiments of the present disclosure may have a first modular skid with one or more elements of the equipment (e.g., a valve actuator or a valve connection flange) at a height above the first modular skid base and extending a distance outside of the first modular skid base width/length dimensions, and a second modular skid with an equipment unit configuration different from the first modular skid equipment, where both the first and second modular skids may have the same mounting footprint (e.g., a base with substantially the same width/length dimensions).

As described above, each modular skid in a modular skid system according to some embodiments of the present disclosure may have the same mounting footprint. However, in some embodiments, such as described in more detail below, a modular skid system may include one or more modular skids having a mounting footprint with one or more irregularities compared with the mounting footprints of the remaining modular skids, such that the modular skids in the modular skid system have substantially the same mounting footprints (i.e., have the same general base dimensions not including the one or more irregularities). For example, in some embodiments, a modular skid system having modular skids with bases of the same general width and length and with connection points at axial ends of the base length may include a Tee-configuration modular skid having base with an additional connection point extending past the width of the majority of the base, while the remaining modular skids in the modular skid system may have bases without such irregularities in the base width formed by an additional connection point. In such embodiments, the Tee-configuration modular skid may be said to have the same mounting footprint as the remaining modular skids in the modular skid system.

The size of modular skids (including the size of modular skid mounting footprints, modular skid heights, equipment configurations arranged on the modular skids, etc.) may be selected based, for instance, on the size limitations of common transportation means, Department of Transportation (DOT) requirements (e.g., to meet weight and size limits of loads being transported on roads by trailers), the type of function each modular skid is to perform, and/or to provide reduced cost and reduced time to manufacture. For instance, the size of the mounting footprint of modular skids may be selected so that three modular skids may fit end to end on a flatbed trailer. In some embodiments, the overall size of modular skids (including the mounting footprints and the size of the equipment held on the modular skids) may be selected such that one or more modular skids may be mounted to a flatbed trailer and also meet DOT regulations for transporting the loaded flatbed trailer.

For example, according to embodiments of the present disclosure, a modular skid may have a mounting footprint having a length ranging from, e.g., a lower limit selected from 7 ft, 10 ft or 14 ft to an upper limit selected from 14 ft or 28 ft, and a width ranging from, e.g., a lower limit selected from 4 ft, 6 ft or 8 ft to an upper limit selected from 6 ft, 8 ft, 10 ft, or 12 ft, where any lower limit may be used in combination with any upper limit. For example, in some embodiments, a modular skid may have a mounting footprint of about 8.5 ft wide and about 11.5 ft long. However, the dimensions of the mounting footprint of a modular skid may vary within the above-mentioned ranges or may be outside of the above-mentioned ranges, depending, for example, on the job the modular skid is designed to perform, DOT regulations, and/or other factors. For example, in some embodiments, the length of the mounting footprint for a modular skid may be designed to correspond with pump spacing when the modular skid is to be used in a pumping operation.

Further, in some embodiments, a modular skid may have a height ranging from, e.g., a lower limit selected from 2 ft, 4 ft or 6 ft to an upper limit selected from 10 ft, 14 ft, or 18 ft, where any lower limit may be used in combination with any upper limit. However, the height of a modular skid may be outside the above-mentioned ranges, depending, for example, on the job the modular skid is designed to perform, DOT regulations, and/or other factors. For example, in some embodiments, modular skids may be designed to have the same or different heights (depending on the types of equipment units being held on each modular skid), where the height of each of the modular skids may be about 10.6 ft or less. In instances where modular skids are being transported on a trailer (and DOT height regulations apply), the height of modular skids may be designed to be no greater than the regulation height minus the height of the trailer on which the modular skids are mounted to.

When modular skids according to embodiments of the present disclosure are connected together to form a modular skid system, equipment units held in different modular skid types may also be connected together to form a primary manifold having a continuous flow path formed therethrough with limited connection. Thus, modular skids according to embodiments of the present disclosure may include substantially uniform mounting footprints in addition to equipment configured to align and/or connect with equipment in adjacently mounted modular skids.

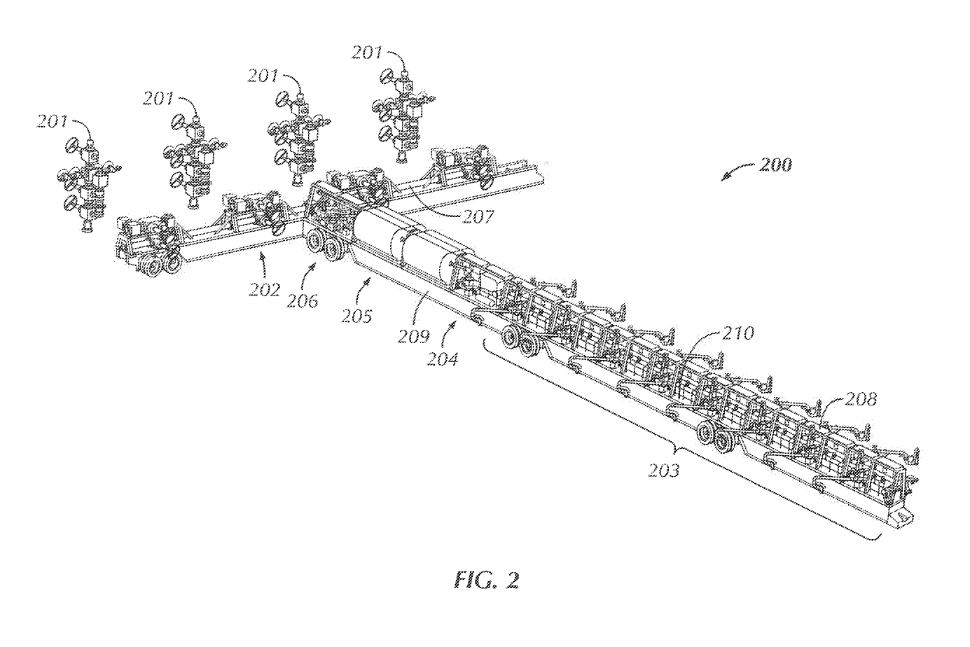

FIG. 2 illustrates a modular skid system 200 according to embodiments of the present disclosure made of a plurality of connected-together modular skids. The modular skid system 200 may be connected at one end to one or more pumps, and may be connected at another end to at least one wellhead 201. The modular skid system 200 couples with the at least one wellhead 201 by using at least one time and efficiency (TE) manifold skid or zipper manifold modular skid 202. A zipper manifold modular skid 202 refers to a modular skid that is purpose built for connection to a wellhead, which may include an outlet head (which may be referred to as a fracturing head or goat head in fracturing operations) for connection to the wellhead and one or more gate valves. The zipper manifold equipment may be arranged to fit on a modular skid having a selected mounting footprint, where the base of the zipper manifold skid 202 may have a mounting footprint with a selected width and length.

Typically, spacing of the wellheads 201 may range from 6 feet to 10 feet, and thus, the at least one zipper manifold modular skid 202 may be designed to align with known spacing of the wellheads 201. For example, the zipper manifold modular skids 202 may be designed to have a mounting footprint with a selected length that corresponds with an interval between wellheads 201, and/or spacer modular skids 207 may be provided between the zipper manifold modular skids 202 to provide closer alignment of the spacing between the zipper manifold modular skids 202 with the spacing between the wellheads 201. As used herein, spacer modular skids refer to modular skids that are purpose built to provide spacing between adjacent modular skids, which may include equipment to connect between the equipment in the adjacent modular skids. One skilled in the art will appreciate how piping may be used to couple the wellheads 201 to the at least one zipper manifold modular skid 202 (e.g., if the spacing between the outlet heads on the zipper manifold modular skids do not align with the wellhead spacing and/or if there is irregular wellhead spacing). One skilled in the art will appreciate how the modular skid system 200 is not limited to a set number of wellheads 201. For example, additional zipper manifold skids 202 may be added to the modular skid system 200 to connect to additional wellheads 201.

In one or more embodiments, the modular skid system 200 may include at least one pump modular skid 203. The pump modular skid 203 may be used in the oil and gas production industry to perform servicing operations on a well by connecting a system manifold to a pump. For example, in a well fracturing operation the pump modular skid 203 may be used to inject a slurry into the wellbore in order to fracture the hydrocarbon bearing formation and thereby produce channels through which the oil or gas may flow by providing a fluid connection between the pump discharge of a pump and a primary manifold system. In this operation, the pump modular skid 203 may connect a number of high pressure pumping units (not shown) to the wellheads 201. A pump modular skid may include pump connection equipment, such as an articulating fracturing arm (AFA) equipment unit. The pump connection equipment (e.g., AFA manifold equipment) may be arranged to fit on a modular skid having a selected mounting footprint, where the base of the pump modular skid 203 may have a mounting footprint with a selected width and length.

In some embodiments, a modular skid system may be formed without a pump modular skid. For example, in some embodiments, a modular skid system may be connected to one or more pumps using standard manifold rig-up, for example, using conventional piping (e.g., 3-inch iron piping) extending from a modular skid in the modular skid system to a pump.

In one or more embodiments, the modular skid system 200 may include at least one auxiliary modular skid 204. The auxiliary modular skid 204 may provide a universal power and control unit, including a power unit and a primary controller, of the modular skid system 200. Furthermore, the universal power and control unit within the auxiliary modular skid 204 may contain programmable logic controllers (PLC), sensors, and solar panel controllers. In one or more embodiments, a programmable logic controller monitors at least one sensor and makes decisions based upon a program to control the state of at least one controllable element. Additionally, the auxiliary modular skid 204 may include one or more electronically controlled pressure relief valves (ePRV) which may be electrically powered and require no gas bottles or hoses. For example, an auxiliary modular skid may include a universal power and control unit and two ePRVs. The ePRV may pop open in the event power is lost, unless a battery backup is employed. The power manifold equipment may be arranged to fit on a modular skid frame having a selected mounting footprint, such that the base of the auxiliary modular skid 204 may have a mounting footprint with a selected width and length.

In one or more embodiments, the modular skid system 200 may include at least one pop-off/bleed-off tank modular skid 205. The pop-off/bleed-off tank modular skid 205 may be used in the oil and gas production industry to perform servicing operations on a well. For example, in a well fracturing operation the pop-off/bleed-off tank modular skid 205 may allow discharge pressure from bleed off/pop off operations to be immediately relieved and controlled. At the conclusion of high-pressure tests or treatments, the pressure within the associated systems must be bled off safely to enable subsequent phases of the operation to continue. The bleed off process must be conducted with a high degree of control to avoid the effect of sudden depressurization, which may create shock forces and fluid-disposal hazards. Thus, the pop-off/bleed-off tank modular skid 205 may equalize or relieve pressure from a vessel or system by collecting fluid bled-off from the system. The pop-off/bleed-off tank equipment may be arranged to fit on a modular skid frame having a selected mounting footprint, where the base of the pop-off/bleed-off tank modular skid 205 may have a mounting footprint with a selected width and length substantially equal to the dimensions of the mounting footprints of the remaining modular skids in the modular skid system.

In one or more embodiments, the modular skid system 200 may include at least one isolation modular skid 206. The isolation modular skid 206 may be used in the oil and gas production industry to perform servicing operations on a well. For example, in a well fracturing operation an isolation modular skid may be used to allow pump-side equipment and well-side equipment to be isolated from each other. Additionally, the isolation modular skid 206 may be capable of being simultaneously attached to multiple external holding vessels (e.g., pop-off/bleed-off tanks) and directing wellbore fluid bled-off from the well-side equipment or from the pump-side equipment to any of the external holding vessels. In some embodiments, the isolation modular skid 206 may be connected to only one external holding vessel and may be capable of directing fluid from either the well-side equipment or from the pump-side equipment to the same external holding vessel. Thus, the well isolation unit may provide more options for bleeding off well-side and pump-side equipment than traditional well isolation equipment. In the embodiment shown, the isolation modular skid 206 may include a bleed-off manifold fluidly connected to the pop-off/bleed-off tanks held in the pop-off/bleed-off tank modular skid 205, such that fluid bled off from the isolation equipment may be collected in the pop-off/bleed-off tanks.

Further, the isolation modular skid 206 may allow piping components with larger inner diameters than the piping components used in traditional wellbore operation systems to be used to perform wellbore operations by configuring the isolation equipment to have a primary manifold connection (e.g., one or more primary flow paths extending between a single primary manifold inlet and a single primary manifold outlet) with multiple isolation valves disposed along the primary manifold connection. The well isolation unit disclosed herein may include automated valves. Further, the isolation equipment may be arranged to fit on a modular skid frame having a selected mounting footprint, such that the base of the isolation modular skid 206 may have a mounting footprint with a selected width and length substantially equal to the dimensions of the mounting footprints of the remaining modular skids in the modular skid system. The modular skids 202, 203, 204, 205, 206, 207 may align together to form an interconnected super structure. One skilled in the art will appreciate how the modular skid system 200 is not limited to a set number of modular skids but may have any number modular skids needed to perform a required job parameter.

In one or more embodiments, the modular skids 202, 203, 204, 205, 206, 207 include primary manifold connections 210 that extend a length of the each of the modular skids 202, 203, 204, 205, 206, 207, such that when the primary manifold connections are connected together, a continuous primary flow path may be formed through the connected-together modular skids 202, 203, 204, 205, 206, 207.

The term primary may be used herein to describe lines, manifold connections, and other flow paths that, when connected together, are used to transport fluid between a pump and a well. For example, as used herein, a primary manifold connection refers to a piping or body having one or more primary flow paths formed therethrough which may carry fluid between a pump and a well. In addition to a primary manifold connection, modular skids of the present disclosure may also include one or more secondary lines, manifold connections, and/or other flow paths for use in secondary functions of the system (i.e., functions other than transporting fluid between a pump and a well). For example, modular skids of the present disclosure may include one or more secondary subsystems, such as a priming subsystem, a bleed-off subsystem, chemical injection, and/or others, where a secondary subsystem may be formed of one or more connected-together secondary flow paths.

As an example, the modular skid system 200 shown in FIG. 2 may include connected-together primary manifold connections 210 extending through the entire modular skid system 200, where when the modular skid system 200 is connected to the pumps and wellheads 201, the connected-together manifold connections 210 provide a continuous primary flow path from the pumps to the wellheads 201. The modular skid system 200 may further include at least one secondary subsystem, including a bleed-off manifold, which may be provided, for example, on the isolation modular skid 206. The bleed-off manifold may be formed of one or more secondary flow paths having one or more valves disposed thereon and one or more secondary outlets. The secondary outlets to the bleed-off manifold may be connected to secondary inlets on the pop-off/bleed-off tanks held in the pop-off/bleed-off tank modular skid 205, such that the bleed-off manifold in the isolation modular skid 206 may be fluidly connected to the pop-off/bleed-off tanks in the pop-off/bleed-off tank modular skid 205.

According to embodiments of the present disclosure, primary manifold connections may have a single primary inlet and a single primary outlet with one or more primary flow paths extending therebetween. For example, a modular skid may have a primary manifold connection with single primary inlet at a first axial end of the primary manifold connection and a single primary outlet at an opposite axial end of the primary manifold connection, where a single primary flow path may extend therebetween (e.g., where the primary inlet, primary outlet and primary flow path may have substantially the same inner diameter), or where multiple primary flow paths may extend between the primary inlet and primary outlet (e.g., in parallel). In some embodiments, a primary manifold connection may have more than one primary inlet and/or more than one primary outlet. For example, a primary manifold connection may have a T-configuration including two primary outlets provided at opposite axial ends of the primary manifold connection, a primary flow path extending between the two primary outlets, and a primary inlet provided in a tie-in valve disposed along the primary flow path.

A primary manifold connection having a T-configuration may be provided on a modular skid in a modular skid system to provide the modular skid system with one or more perpendicular bends in the modular skid system configuration. For example, FIG. 2 shows the modular skids 202, 203, 204, 205, 206, 207 of the modular skid system 200 in a T-configuration (having two perpendicular turns). In some embodiments, a modular skid system may have a linear configuration, where modular skids of the modular skid system may each include primary manifold connections having primary inlets and primary outlets at opposite ends of the primary manifold connections, such that the primary manifold connections are connected together in a straight/linear configuration. One skilled in the art will appreciate how a modular skid system is not limited to a set configuration and may be adapted to any configuration based on the job requirements.

Primary manifold connections 210 may be mounted on an A-frame 208 of the modular skids. The A-frame 208 has a base with frame beams extending upward from the base. Additionally, the frame beams are angled inward and are connected with a top beam to create an A shape. The top beam extends from one side of the A-frame 208 to another end of the A-frame 208. It is further envisioned that a frame (support structure) of a modular skid may be any shape suitable to encompass the required equipment and is not limited to being the A-frame shape as shown in FIG. 2. In some embodiments, a modular skid system may include modular skids having differently shaped and/or sized frames, while still maintaining substantially the same mounting footprint. For example, a first modular skid in a modular skid system may include a frame with a selected mounting footprint and a first height, and a second modular skid in the modular system may include a frame with the same selected mounting footprint as the first modular skid but with a second height different from the first height. Furthermore, one skilled in the art will appreciate how the frames of a modular skid may be formed from a base material such as metal, composite, plastic, or any material know in the art to be a suitable frame. Additionally, the frame of a modular skid may be coated with any material know the art to protect the base material.

The primary manifold connection 210 and same-sized mounting footprints of the modular skid frame 208 may allow for the number and order of the modular skids 202, 203, 204, 205, 206, 207 to be easily changed depending on hydraulic fracturing pad design considerations or well conditions. Additionally, the primary manifold connection 210 simplifies the number of connections needed system wide, as the primary manifold connection 210 allows the modular skids 202, 203, 204, 205, 206, 207 to be in fluid communication with a limited number of connections.

Further seen by FIG. 2, the modular skids 202, 203, 204, 205, 206, 207 of the modular skid system 200 are mounted onto at least one trailer chassis 209 prior to deployment to the field. The modular skids 202, 203, 204, 205, 206, 207 may use ISO connection blocks and twist locks (not shown) to mount the modular skids to the at least one trailer chassis 209. In other embodiments, different connection types may be used to connect a modular skid to a chassis or other platform. In some embodiments, the weight of the modular skid and connections to adjacent modular skids (e.g., manifold connections and/or frame connections) may be used to hold the modular skid on a trailer.

Multiples trailer chassis 209 may be used depending on the number of modular skids being used. When using multiple trailer chassis 209, the trailer chassis 209 may be aligned and joined using similar technology to removable gooseneck trailers. In mounting the modular skids 202, 203, 204, 205, 206, 207 to the at least one trailer chassis 209, a field rig-up time may be significantly reduced. As stated above, the at least one trailer chassis 209 may allow for different configurations per job requirements. Additionally, in using the same-sized A-frame 208, the modular skids 202, 203, 204, 205, 206, 207 may have identical mounting footprints, regardless of function. However, it is further envisioned that the modular skids 202, 203, 204, 205, 206, 207 may be transported to the field and placed on a ground or other platform structure instead of using the at least one trailer chassis 209.

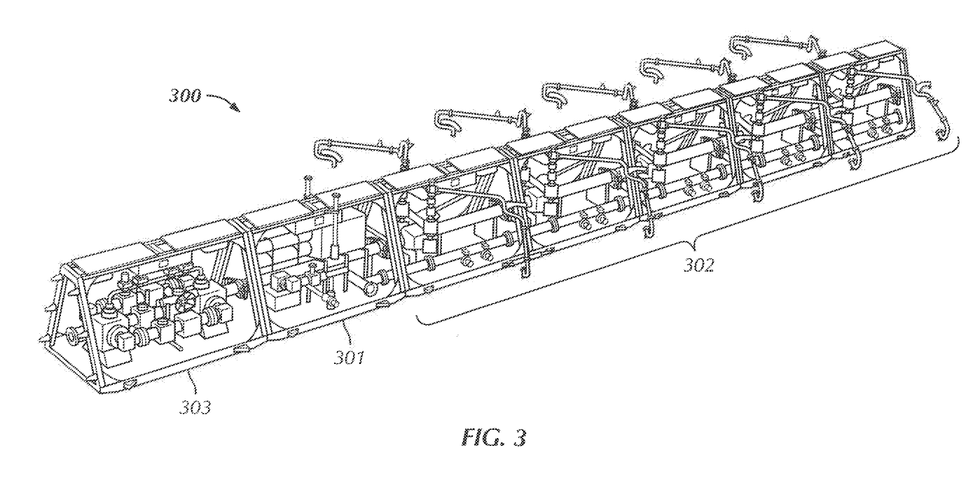

Now referring to FIG. 3, in one or more embodiments, FIG. 3 illustrates a closer look at an example of a plurality of same-size, purpose built modular skids 301 that are connected together to form a unitary skid structure or super structure 300. In the super structure 300, the modular skids 301 are pulled together and aligned. When the modular skids 301 are aligned, elements on the modular skids 301 may also be aligned, including ends of a primary manifold connection 302. In other words, connecting elements on adjacent modular skids may be positioned in the modular skids, such that the connecting elements (e.g., the primary manifold connection 302 ends) may be aligned and connected upon alignment and connection of the adjacent modular skids on which the connecting elements are disposed, thereby making the axial alignment of the connecting elements easier. By simplifying alignment and connection of connecting elements such as the ends of the primary manifold connections 302 on adjacent modular skids 301, the formation of super structure 300 may also be simplified. Further, a primary, high-pressure manifold through the modular skid system may be made up of big bore pipe segments by connecting primary manifold connections 302 having a reduced number of connections (e.g., a single primary inlet and a single primary outlet).

Rotationally independent connectors 303 may be used in conjunction with a manifold alignment system so that a rotational alignment of the primary manifold connection 302 may be ignored. For example, once ends of primary manifold connections 302 are aligned and pulled toward each other (e.g., either until the ends contact each other or to a distance apart to allow positioning of a rotationally independent connector therebetween), a rotationally independent connector 303 may be positioned to connect ends of the primary manifold connections 302 together to create a high-pressure seal. For example, in some embodiments, ends of primary manifold connections 302 in adjacent modular skids 301 may be axially aligned and pulled together until they contact each other. A rotationally independent connector 303 may then be positioned around the contacting primary manifold connection ends and tightened around the contacting ends to connect the ends together. In another example, ends of primary manifold connections 302 in adjacent modular skids 301 may be axially aligned and pulled to a distance apart to allow positioning of a rotationally independent connector 303 therebetween. The ends of the primary manifold connections 302 may then be moved to an interior of the connector 303, and the connector 303 may be tightened around the ends to connect the primary manifold connections 302.

In one or more embodiments, one or more alignment systems may be used to facilitate an automated alignment process, or at least a simplified alignment process in which one or more of the axial alignments may be more easily performed.

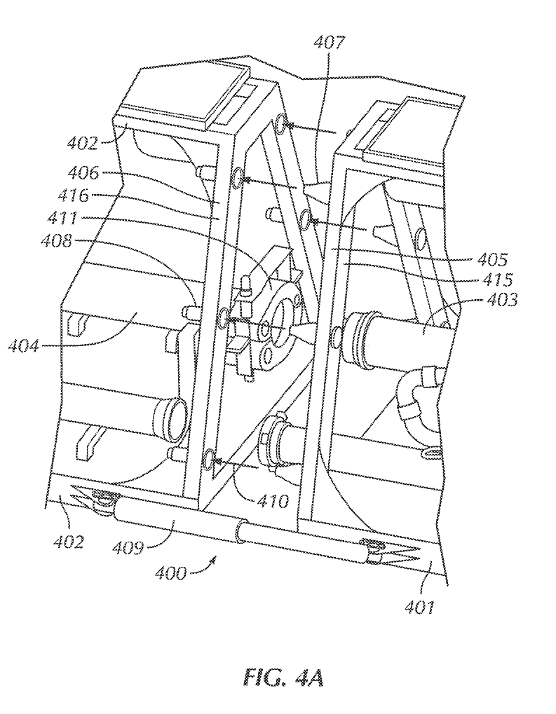

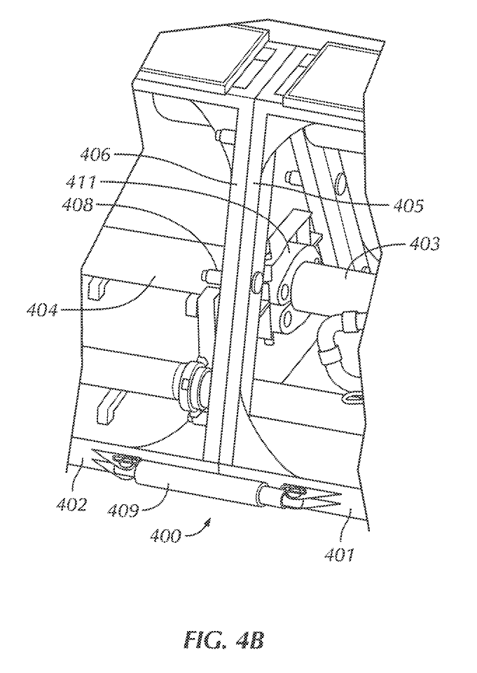

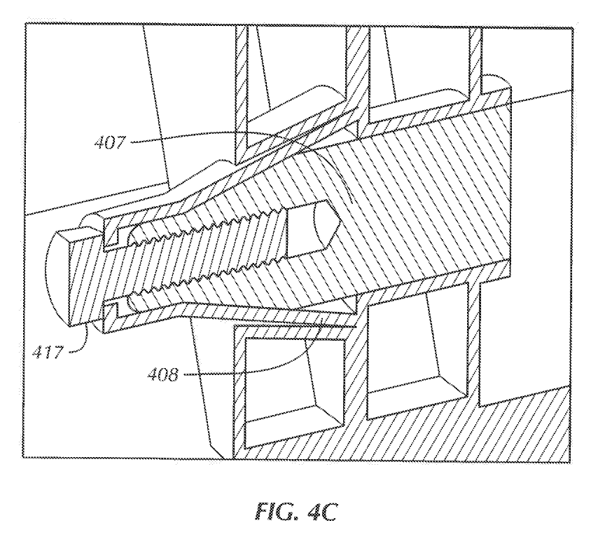

Modular skids may be aligned and connected together to form a super structure using a manifold alignment system according to embodiments of the present disclosure. For example, referring to FIGS. 4A-4B, a manifold alignment system 400 may be used to properly align modular skids 401, 402 together. As can be seen by FIGS. 4A-4B, a first modular skid 401 and a second modular skid 402 each have a primary manifold connection 403, 404. Furthermore, the first modular skid 401 and the second modular skid 402 each have a support structure or frame 405, 406 which surrounds the primary manifold connection 403, 404. The manifold alignment system 400 may include elements disposed on the frame 405, 406 to align the first modular skid 401 and the second modular skid 402. The elements of the manifold alignment system 400 may include a plurality of male cones 407 on a frame beam 415 of the frame 405 on the first modular skid 401, a plurality of female cones 408 on a frame beam 416 of the frame 406 on the second modular skid 402, and a removably mounted hydraulics 409 on an end of the frames 405, 406. The male cones 407 act as a guide to properly align the first modular skid 401 with the second modular skid 402, and as such, the male cones 407 insert into to the female cones 408 in a direction of arrow 410. As seen by FIG. 4C, FIG. 4C shows a cross-section of the male cone 407 when inserted in the female cone 408. Additionally, a fastener 417, such as a bolt, is threaded into an end of the male cone 407 and further secures and pulls the male cone 407 flush with the female cones 408. Referring back to FIGS. 4A-4B, the temporarily mounted hydraulics 409 is configured to draw the frames 405, 406 together. One skilled in the art will appreciate how the removably mounted hydraulics 409 may be added to the frames 405, 406 at any time to aid in pulling the first modular skid 401 and the second modular skid 402 together or apart. Once drawn together, the ends of the primary manifold connections 403, 404 will contact one another in axial alignment such that they can be secured together and pressure tested. The manifold alignment system 400 may increase a speed at which the modular skids can be deployed and pressure tested in the field.

FIGS. 4A-C show an example of an alignment system according to embodiments of the present disclosure. However, other alignment systems may be used to align and/or connect modular skids according to embodiments of the present disclosure. For example, alignment systems according to embodiments to the present disclosure may include more or less elements than the example alignment system shown in FIGS. 4A-C (e.g., more or less pairs of mating cones, or no hydraulics are mounted to the modular skids). In some embodiments, different elements may be used to align modular skids, such as one or more pairs of mating sloped surfaces formed in or attached to the frames of the modular skids. In some embodiments, rather than using removable mounted hydraulics to pull modular skids together or apart, hydraulic mechanisms may be used to push modular skids together or modular skids may be manually pushed together and/or manually pulled apart.

In one or more embodiments, one or more rotationally independent connectors 411, e.g., clamps, greyloc hubs, KL4 connectors, may be used to avoid the need to rotationally align a flanged connection between the primary manifold connections 403, 404, where rather than rotationally aligning connection points on primary manifold connections to connect them together, the primary manifold connections 403, 404 may be axially aligned and held together by positioning the rotationally independent connector 411 around the ends of the axially aligned primary manifold connections 403, 404. In some embodiments, the rotationally independent connectors 411 may be attached to the end of one of the pipe segments to reduce the amount of work necessary to make up the connection.

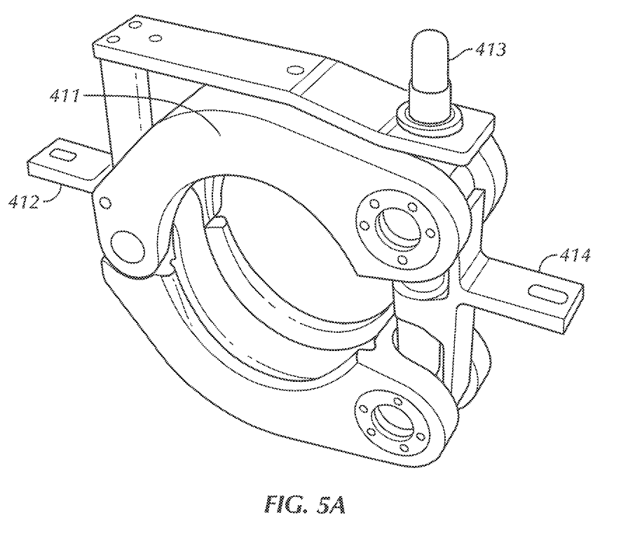

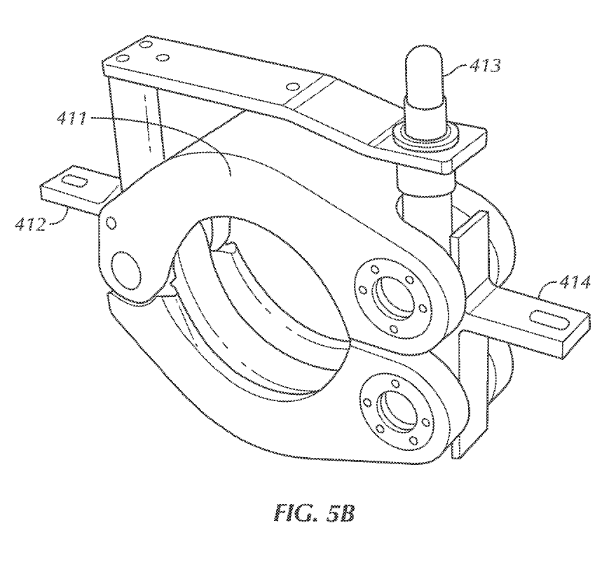

Referring now to FIGS. 5A-5B, in one or more embodiments, FIGS. 5A-5B illustrates the rotationally independent connector 411 that facilitates an alignment of primary manifold connections (e.g., 403, 404 in FIGS. 4A-4B) alone or in conjunction with a plurality of male cones (e.g., 407 in FIGS. 4A-4B), a plurality of female cones (e.g., 408 FIGS. 4A-4B), and temporarily mounted hydraulics (e.g., 409 in FIGS. 4A-4B). FIG. 5A shows the rotationally independent connector 411 in an open position to allow primary manifold connections to be inserted. As seen by FIG. 5B, the rotationally independent connector 411 is in a closed position to align and connect the primary manifold connection. Additionally, in the closed position, rotationally independent connector 411 may aid in providing a proper seal between the primary manifold connections.

According to some embodiments, the rotationally independent connector 411 may be connected to a modular skid frame by a mounting bracket 414 on a side of the rotationally independent connector 411. For example, the rotationally independent connector 411 may be mounted on the frame 406 of the second modular skid 402 or may be mounted on the frame 405 of the first modular skid 401 shown in FIGS. 4A-B. It is further envisioned, that one of the ends of the rotationally independent connector 411 may be tapered, and the opposite end may have an inner surface that accepts the taper so that the ends may more easily align. In some embodiments, the rotationally independent connector 411 may be torqued closed or opened by a single bolt 413. For example, the rotationally independent connector 411, such as a KL4 connector, advantageously only has one point of actuation and thus may use a single bolt (e.g., bolt 413) for connection. As such, the rig up time may be significantly reduced by having one point of actuation rather than making multiple flange bolting connections, or even 4 bolts on the grayloc clamp. Additionally, the rotationally independent connector 411 may include a locking feature (not shown) on the single bolt 413. The locking feature ensures the single bolt 413 will not back out or open the rotationally independent connector 411.

Other types and configurations of rotationally independent connectors may be used to clamp together axially aligned manifold connections. For example, rotationally independent connectors may include different configurations of hinged arms shaped to fit around (partially or entirely) ends of manifold connections. One or more attachment mechanisms may be used to attach the hinged arms of a rotationally independent connector together around the ends of manifold connections. In some embodiments, rotationally independent connectors may include two independent arms, which may be attached together around ends of manifold connections at opposite ends of the arms. Arms (hinged or unhinged) of a rotationally independent connector may be shaped to correspond with an outer profile of ends of manifold connections. For example, arms of a rotationally independent connector may have a curved interior profile that may correspond with a curved outer profile of a manifold connection.

Further, rotationally independent connectors may be used to connect ends of primary manifold connections and/or secondary manifold connections during alignment and/or attachment of skids.

In one more embodiments, other alignment elements may be used that are known in the art. For instance, height adjustable or leveling mechanisms can be incorporated into the structure of a modular skid (e.g., on the frames 405, 406 shown in FIGS. 4A-B) or provided under a modular skid. In some embodiments, a plurality of swivel mechanisms may be incorporated into primary manifold connections (e.g., connections 403, 404) to facilitate the makeup of flanged connections. In some embodiments, alignment and pulling elements may be incorporated into the ends of primary manifold connections.

One example element of incorporated alignment and pulling elements is a “soft landing/hard landing” assembly, which may be used for landing assemblies in subsea applications. In a soft landing/hard landing assembly, a shoulder and a latching mechanism may be positioned on the ends of connections. The shoulder on an end of a first connection may act as a contact surface for the end of a second connection. When the shoulder contacts the end of the second connection, a latching mechanism may catch with the end of the first connection, pull the first and second connections together, and complete the connection.

As described above, the soft landing/hard landing feature has been previously designed for subsea applications to prevent damage to the sealing surfaces/seals during installation. For example, when stabbing a subsea tree onto a wellhead, due to the waves/swells at sea, the subsea tree may damage or slam down onto the wellhead during installation. In such the case, seals may be damaged if the subsea tree is landed on the wellhead too hard and the stabbing process may have to be repeated. However, the hard landing/soft landing feature is designed with a surface/stop that allows the subsea tree to be slammed down onto the wellhead. The surface/stop ensures the subsea tree being slammed will not contact and/or damage the seals/sealing surfaces of either the subsea tree or the wellhead. Once the subsea tree is resting on the wellhead (e.g., from an initial hard landing or soft landing), the soft landing/hard landing feature is engaged and gently pulls the connections of the subsea tree and the wellhead together (typically either mechanically or hydraulically). Additionally, the soft landing/hard landing feature may simultaneously engage the seals safely and without damaging anything.

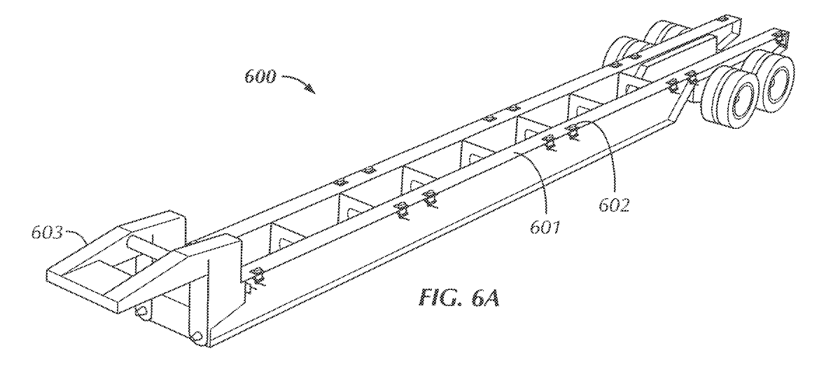

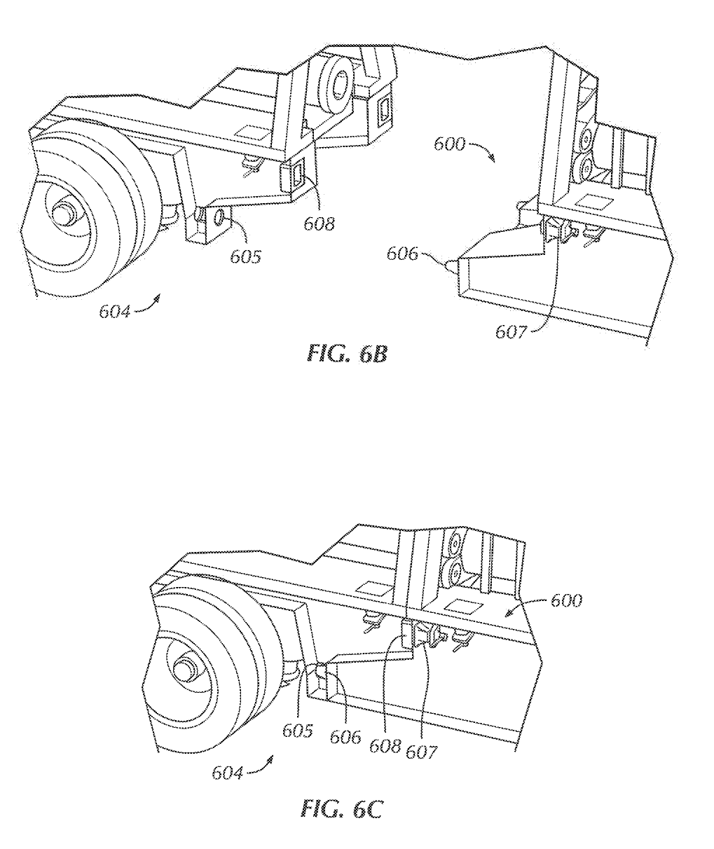

Trailer chassis according to embodiments of the present disclosure may utilize a soft landing/hard landing assembly between connections on the ends of the trailer chassis. For example, as described in FIGS. 6A-6C, trailer chassis according to embodiments of the present disclosure may have a soft landing/hard landing assembly formed at the connection ends of the trailer chassis. The trailer chassis be transported to a rig by being driven. As such, big rig drivers may be contracted to transport the trailer chassis. However, the level of skill of the big rig drivers may be inconsistent, and thus, relying on the big rig drivers to gently back a first trailer chassis into a second trailer chassis may be problematic. If big rig drivers back up too fast and slam the trailer chassis together, damages may occur to the seals and/or sealing surfaces on connection ends of the trailer chassis and/or the modular skids. Therefore, a soft landing/hard landing may be adapted on connection ends of either the trailer chassis and/or the modular skids, which may allow the big rig driver to slam into a mating trailer (on purpose or accident), without actually making initial contact with the seals and/or sealing surfaces. Once landed, a latching feature/hydraulic pull system may gently pull the trailer chassis and/or the modular skids together safely and gently engage the main seals.

In some embodiments, the latching feature/hydraulic pull system may have a plurality of hydraulic rams sticking out of a connection end (e.g., back) of the trailer chassis. The big rig driver may then back a trailer chassis into the plurality of hydraulic rams. Once the trailer chassis makes contact, the plurality of hydraulic rams may automatically lock into the mating trailer, and then hydraulically pull the trailer chassis into position to engage the seals and secure the connection.

As seen by FIGS. 6A-6C, in one more embodiments, perspective views of a trailer chassis 600 is shown. The trailer chassis 600 has a top surface 601 adapted to be a carrier for modular skids, such as described herein. Furthermore, the top surface 601 may be configured to lock the modular skids in place with a plurality of ISO retractable twist locks 602 or any known locking device known in the art. FIG. 6A illustrates the trailer chassis 600 utilizing a removable gooseneck 603 as known in the art. The removable gooseneck 603 may allow the trailer chassis 600 to be easily coupled to a motor vehicle (not shown) and removed if the trailer chassis 600 needs to be connected to a second trailer chassis 604 (shown in FIGS. 6B-6C).

Further, seen by FIGS. 6B-6C, a plurality of male connections 606 on the trailer chassis 600 may be inserted into a plurality of female connections 605 on the second trailer chassis 604 to aid in proper alignment of the two trailers 600, 604. Furthermore, a plurality of trailer twist locks 607 on the trailer chassis 600 may engage and lock a plurality of ISO connection blocks 608 on the second trailer chassis 604, thereby, locking the two trailers 600, 604 together. It is further envisioned that the two trailers 600, 604 may be coupled together by a means of any mechanical fastener and not limited to the plurality of trailer twist locks 607 and the plurality of ISO connection blocks 608 shown in FIGS. 6A-6C. Additionally, hydraulics may be used in conjunction or alone of the mechanical fastener. Furthermore, connection technologies such as a soft/hard landing assembly may be used to couple the two trailers 600, 604. In some embodiments, the two trailers 600, 604 may be welded together or use adhesives.

According to embodiments of the present disclosure, the modular skid system may include a plurality of trailer chassis (such as described FIGS. 6A-6C) adapted to be a carrier for modular skids. Furthermore, the primary flow line of the modular skid system may be connected-together by physically attaching the plurality of trailer chassis together in the field. For example, a first modular skid may be mounted on a first trailer and a second modular skid may be mounted on a second trailer. The first modular skid may be connected to the second modular skid without removing the first modular skid from the first trailer or the second modular skid from the second trailer. Additionally, the connecting of the first modular skid to the second modular skid may include connecting the first trailer to the second trailer. For example, the first modular skid may be positioned at a first connection end of the first trailer and the second modular skid may be positioned at a second connection end of the second trailer, such that when the first and second connection ends of the first and second trailers contact, the connection ends of the first and second modular skids also contact. It is further envisioned that the first modular skid from the first trailer may be connected to the second modular skid from the second trailer by using piping (i.e., ground iron) and with or without connecting the first trailer to second trailer.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. A manifold alignment system, comprising:
a first modular skid with a first frame, the first frame having a first end with at least one first sloped surface;
a second modular skid with a second frame, the second frame having a second end with at least one second sloped surface, wherein the at least one first sloped surface mates with the at least one second sloped surface; and
a removably mounted hydraulic mechanism attached to the first end of the first skid and the second end of the second skid.

2. The system of claim 1, further comprising a rotationally independent connector mounted on the first frame or the second frame, wherein the rotationally independent connector has an opening to seal a first manifold connection on the first modular skid and a second manifold connection on the second modular skid together.

3. The system of claim 2, further comprising a single bolt to open and close the rotationally independent connector.

4. The system of claim 2, further comprising a mounting bracket on a side of the rotationally independent connector to mount the rotationally independent connector on the first frame or the second frame.

5. The system of claim 2, wherein the rotationally independent connector is a clamp, a greyloc hub, or a KL4 connector.

6. The system of claim 1, wherein the at least one first sloped surface is a male cone, and the at least one second sloped surface is a female cone sized to fit flush with the at least one male cone.

7. The system of claim 1, further comprising a fastener to attach the at least one first sloped surface to the at least one second sloped surface.

8. The system of claim 1, wherein the first end of the first frame and the second end of the second frame are attached flush against each other.

9. The system of claim 1, wherein the first modular skid and second modular skid are attached together to form a super structure.

10. The system of claim 1, wherein the first modular skid and second modular skid have a mounting footprint with the same size.

11. The system of claim 1, wherein the first frame and second frame comprise a base with a plurality of frame beams extending upward from the base, wherein the plurality of frame beams are angled inward and are connected with a top beam.

12. The system of claim 11, wherein the at least one first sloped surface is disposed on the frame beams of the first frame and the at least one second sloped surface is disposed on the frame beams of the second frame.

13. The system of claim 1, further comprising a soft landing/hard landing feature on the first modular skid and/or the second modular skid.

14. The system of claim 1, further comprising at least one trailer, wherein the first and second modular skids are mounted to the at least one trailer.

15. The system of claim 14, further comprising a soft landing/hard landing feature on the at least one trailer, wherein the soft landing/hard landing feature comprises a latching feature and a hydraulic pull system.

16. The system of claim 1, further comprising a first trailer and a second trailer, wherein he first and second modular skids are mounted on the first trailer and the second trailer respectively.

17. The system of claim 16, wherein the first trailer comprises a first connection end and the second trailer comprises a second connection end, and the first connection end mates with the second connection end.

18. The system of claim 17, wherein the first connection end comprises at least one a male cone, and second connection end comprises at least one a female cone sized to fit flush with the at least one male cone.

19. A method of aligning a plurality of skids, comprising:
pulling a first modular skid towards a second modular skid with a removably mounted hydraulic mechanism or a crane, wherein the first modular skid comprises a first frame and the second skid comprises a second frame;
axially aligning a first manifold connection on the first modular skid with a second manifold connection on the second modular skid; and
closing a rotationally independent connector around axially aligned ends of the first manifold connection and the second manifold connection to fluidly connect the first manifold connection to the second manifold connection.

20. The method of claim 19, wherein axially aligning comprises inserting at least one male cone disposed on the first frame of the first modular skid in at least one female cone disposed on the second frame of the second modular skid.

21. The method of claim 20, further comprising tightening a fastener to seal the at least one male cone to the at least one female cone.

22. The method of claim 20, further comprising sizing the at least one male cone to fit flush in the at least one female cone.

23. The method of claim 20, further comprising torqueing a single bolt to open and close the rotationally independent connector.

24. The method of claim 23, further comprising locking the single bolt with a locking feature.

25. The method of claim 19, wherein closing the rotationally independent connector aligns the first manifold connection and the second manifold connection flush together.

26. The method of claim 19, wherein the removably mounted hydraulic mechanism pushes the first modular skid and the second modular skid apart.

27. The method of claim 19, further comprising using a leveling mechanism to adjust the height of the first modular skid or the second modular skid.

28. The method of claim 19, further comprising:
mounting the first modular skid on a first trailer, mounting the second modular skid on a second trailer; and
connecting the first modular skid to the second modular skid without removing the first modular skid from the first trailer or the second modular skid from the second trailer.

29. The method of claim 28, wherein connecting the first modular skid to the second modular skid comprises connecting the first trailer to the second trailer.

30. The method of claim 19, further comprising mounting the first and second modular skids on a trailer and transporting the connected-together first and second modular skids on a trailer.
